(19) United States
(12) Patent Application Publication
(10) Pub. No.: US 2008/0039112 A1
(43) Pub. Date: Feb. 14, 2008

(54) METHOD AND APPARATUS FOR DEDICATED RESOURCE REQUEST USING CONGESTION INFORMATION IN MOBILE COMMUNICATION SYSTEM

(75) Inventor: Mi-Hee PARK, Yongin-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/837,308

(22) Filed: Aug. 10, 2007

(30) Foreign Application Priority Data
Aug. 10, 2006 (KR) 2006-0075589

(51) Int. Cl. H04Q 7/20

(52) U.S. Cl. 455/453

(57) ABSTRACT

A method and apparatus for a dedicated resource request using congestion information in a mobile communication system. The method includes determining a dedicated resource state of a cell connected to a mobile terminal using system information from the cell, when the mobile terminal requests a dedicated resource, selecting or reselecting, at the mobile terminal, a neighboring cell that is not congested when the dedicated resource of the cell is congested, and requesting, at the mobile terminal, the dedicated resource from the neighboring cell.

### PRIORITY

This application claims priority under 35 U.S.C. § 119 to an application filed in the Korean Intellectual Property Office on Aug. 10, 2006 and assigned Serial No. 2006-75589, the contents of which are incorporated herein by reference.

### BACKGROUND OF THE INVENTION

1. Field of the Invention

The present invention generally relates to a mobile communication system, and in particular, to a method and apparatus for selecting/reselecting and camping on a cell that can allocate a dedicated resource to a mobile terminal by determining whether the dedicated resource of the cell connected to the mobile terminal is congested.

2. Description of the Related Art

The phrase ‘camp on’, as used herein, means that while residing in a cell, a mobile terminal receives a service from the cell after the mobile terminal connects to the cell and until the mobile terminal moves to another cell.

FIG. 1 shows a dedicated resource request process in a conventional mobile communication system. A mobile terminal 105 camps on a cell A 110. Then, in step 115, a network apparatus of the cell A 110 periodically broadcasts system information and the mobile terminal 105 receives the system information.

When a dedicated resource of the cell A 110 becomes congested in step 120, and the mobile terminal 105 requests the dedicated resource from the cell A 110 in step 125, the cell A 110 rejects the dedicated resource request in step 130. Thus, the mobile terminal 105 cannot obtain dedicated resource and receive a corresponding service (e.g., a voice call service).

As a result, a need exists for a method and apparatus for selecting/reselecting and camping on a neighboring cell that is not congested when, for example, the mobile terminal 105 previously determines whether the dedicated resource of the cell A 110 is congested.

### SUMMARY OF THE INVENTION

The present invention substantially solves at least the above problems and/or disadvantages and provides at least the advantages below. Accordingly, an aspect of the present invention is to provide a method and apparatus for a dedicated resource request using dedicated resource congestion information in a mobile communication system.

Another aspect of the present invention is to provide a method and apparatus for selecting/reselecting a neighboring cell that is not congested when a mobile terminal determines whether the dedicated resource of a cell connected to the mobile terminal is congested.

According to an aspect of the present invention, provided is a method for a dedicated resource request using congestion information in a mobile communication system, the method including determining a dedicated resource state of a cell connected to a mobile terminal using broadcasted system information from the cell, when the mobile terminal requests a dedicated resource, selecting/reselecting, at the mobile terminal, a neighboring cell that is not congested when the dedicated resource of the cell is congested, and requesting, at the mobile terminal, the dedicated resource from the neighboring cell.

According to another aspect of the present invention, provided is an apparatus for a dedicated resource request using congestion information in a mobile communication system, the apparatus including a controller for receiving system information from a network apparatus of a cell, providing congestion information of the cell included in the system information to a dedicated resource determiner, and instructing the dedicated resource determiner to determine whether to request a dedicated resource from the cell or to request the dedicated resource from a neighboring cell when the dedicated resource is requested, and the dedicated resource determiner for determining whether to request the dedicated resource from the cell or to request the dedicated resource from the neighboring cell according to an instruction of the controller and the provided congestion information, and providing a determination result.

According to still another aspect of the present invention, provided is a system for a dedicated resource request using congestion information in a mobile communication system, the dedicated resource request system including a network apparatus for broadcasting system information including dedicated resource congestion information of a cell, and a mobile terminal for receiving the system information, selecting/reselecting a neighboring cell that is not congested because the cell is congested when a dedicated resource is requested, requesting and obtaining the dedicated resource from the neighboring cell, and receiving a corresponding service of the dedicated resource.

According to yet another aspect of the present invention, provided is a method for transmitting dedicated resource congestion information in a mobile communication system, the method including incorporating the dedicated resource congestion information of a cell into system information from a network apparatus, and broadcasting, at the network apparatus, the system information including the dedicated resource congestion information.

According to still another aspect of the present invention, provided is an apparatus for dedicated resource allocation using congestion information in a mobile communication system, the apparatus including a controller for broadcasting system information including dedicated resource congestion information of a cell, and a congestion state manager for generating the dedicated resource congestion information and providing the generated dedicated resource congestion information to the controller.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a dedicated resource request process in a conventional mobile communication system;

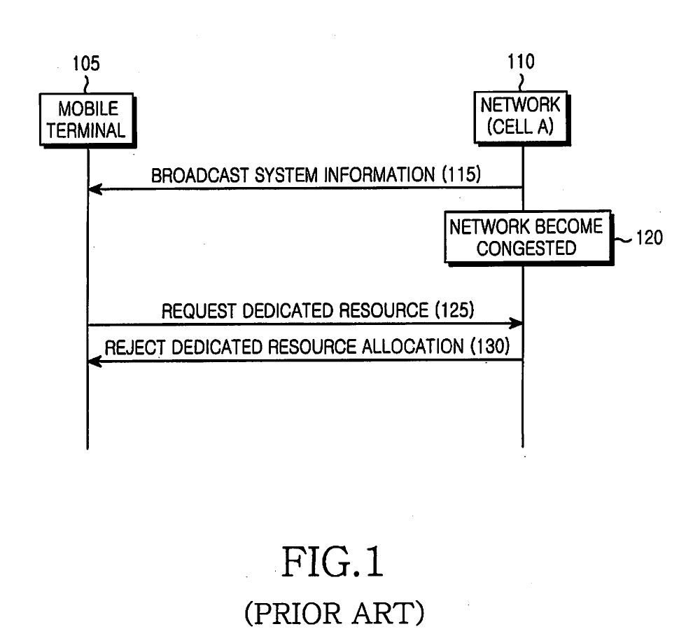

FIG. 2 illustrates a dedicated resource request process in a mobile communication system according to the present invention;

FIG. 3 is a flowchart of an operation process of a mobile terminal according to the present invention;

FIG. 4 is a block diagram of a mobile terminal according to the present invention; and

FIG. 5 is a block diagram of a network apparatus according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would unnecessarily obscure the present invention.

The present invention provides a method and apparatus for a dedicated resource request using congestion information in a mobile communication system.

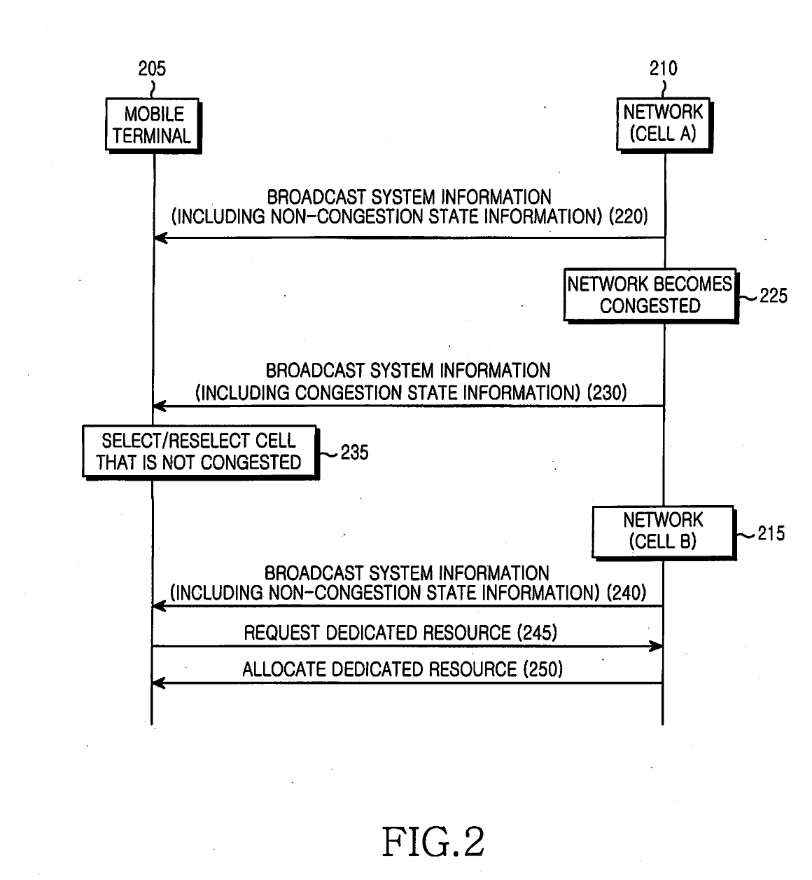

FIG. 2 shows a dedicated resource request process in a mobile communication system according to the present invention. A mobile terminal 205 camps on a cell A 210. Then, in step 220, a network apparatus of the cell A 210 periodically broadcasts system information including current congestion state information of the cell A 210 (in the case of step 220, the cell A 210 is not congested), and the mobile terminal 205 receives the system information. While receiving the system information, the mobile terminal 205 determines whether a neighboring cell is congested by receiving system information of the neighboring cell.

If the cell A 210 enters a congestion state in step 225, the network apparatus of the cell A 210 broadcasts system information including information indicating the congestion state in step 230.

The mobile terminal 205 determines that the cell A 210 is congested using the system information of step 230. In step 235, the mobile terminal 205 detects a cell (e.g., a cell B 215), which is not congested, among neighboring cells using periodically received system information from the neighboring cells, and selects/reselects the cell B 215.

The mobile terminal 205 reselects and camps on the cell B 215 that is not congested. In step 240, a network apparatus of the cell B 215 periodically broadcasts system information including the current congestion information of the cell B 215 (the cell B 210 is not congested in step 240), and the mobile terminal receives the system information.

In step 245, the mobile terminal 205 requests a dedicated resource from the cell B 215. In step 250, the network apparatus of the cell B 215 allocates the dedicated resource to the mobile terminal 205 so the mobile terminal 205 receives a corresponding service of the dedicated resource.

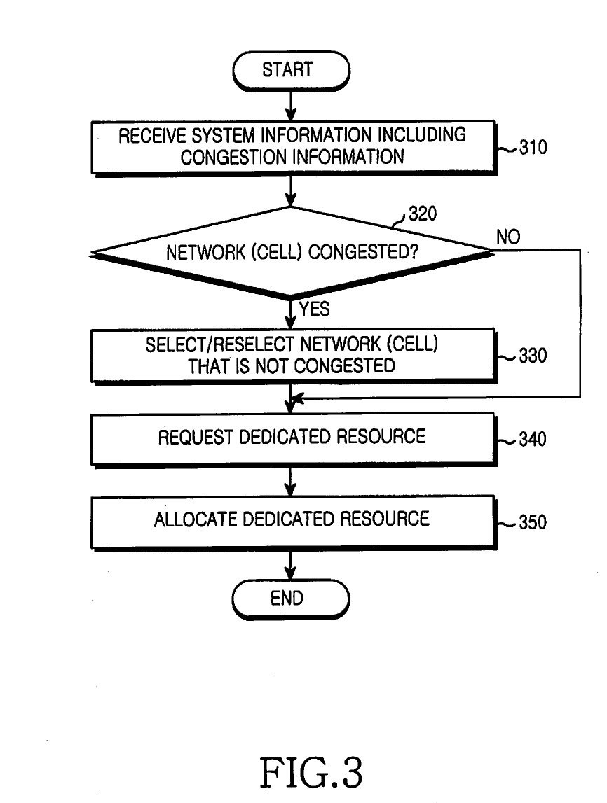

FIG. 3 shows an operation process of a mobile terminal according to the present invention. The mobile terminal camps on a cell. Then, in step 310, the mobile terminal receives system information including congestion information from a network apparatus of the cell. While receiving the system information, the mobile terminal can determine whether a neighboring cell is congested by receiving system information of the neighboring cell.

If the cell is now congested in step 320, the mobile terminal selects/reselects a neighboring cell that is not congested in step 330. In step 340, the mobile terminal requests a dedicated resource from the neighboring cell. In step 350, neighboring cell allocates the dedicated resource to the mobile terminal so the mobile terminal receives a corresponding service of the dedicated resource.

If the cell is not congested, the mobile terminal requests a dedicated resource from the cell in step 340. In step 350, the cell allocates the dedicated resource to the mobile terminal so the mobile terminal receives a corresponding service of the dedicated resource.

Then, the mobile terminal terminates the procedure according to the present invention.

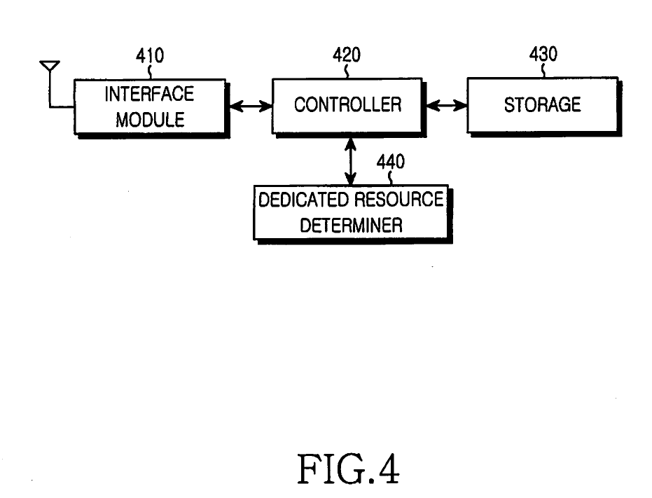

FIG. 4 shows a mobile terminal according to the present invention. A controller 420 receives system information from an interface module 410. The system information includes congestion information and is periodically broadcasted from network apparatuses of a current serving cell and a neighboring cell. The controller 420 provides the received system information to a dedicated resource determiner 440. Under the control of the controller 420, when a dedicated resource is requested, while considering congestion information of the current serving cell, the dedicated resource determiner 440 determines whether to request the dedicated resource from the current serving cell or to request the dedicated resource from a neighboring cell that is not congested. When the controller 420 requests the dedicated resource from the neighboring cell according to a determination result of the dedicated resource determiner 440, the controller 420 reselects the neighboring cell and requests the dedicated resource from the neighboring cell.

Under the control of the controller 420, the dedicated resource determiner 440 determines whether the current serving cell is congested according to the congestion information included in the system information provided from the controller 420. The dedicated resource determiner 440 determines whether to request the dedicated resource from the current serving cell or to request the dedicated resource from a neighboring cell, and provides a determination result to the controller 420.

A storage 430 stores a program for controlling the whole operation of the mobile terminal and temporary data generated during the execution of the program.

The interface module 410 is a module for communicating with another node and includes a Radio Frequency (RF) processor and a baseband processor. The RF processor converts a signal received through an antenna into a baseband signal and provides the baseband signal to the baseband processor. Also, the RF processor converts a baseband signal received from the baseband processor into an RF signal suitable for over-the-air transmission and transmits the RF signal through the antenna.

In the above-described configuration, the controller 420 may perform the functions of the dedicated resource determiner 440. Although separate units are provided for the respective functions of the controller 420, the controller 420 may be configured to perform all or some of the functions of the dedicated resource determiner 440.

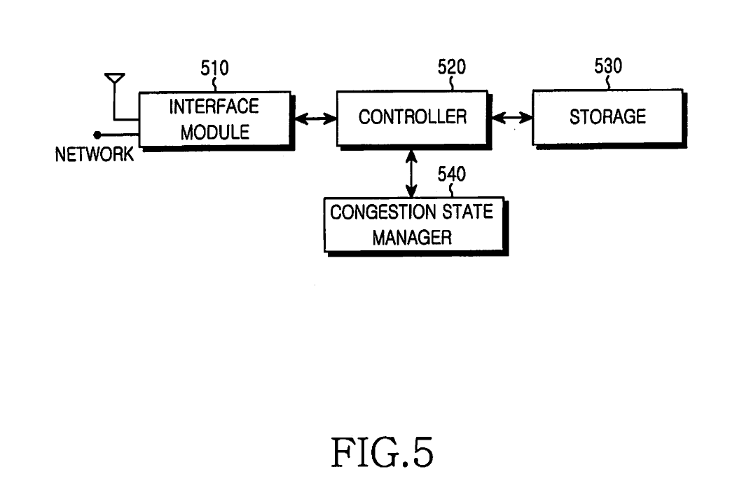

FIG. 5 shows a network apparatus according to the present invention. A controller 520 periodically broadcasts system information related to a current cell through an interface module 510. Under the control of the controller 520, a congestion state manager 540 provides state information of the current cell to the controller 520, and the state information is included in the system information.

Under the control of the controller 520, the congestion state manager 540 checks whether the dedicated channel of the current cell is congested and provides the checked results to the controller 520.

A storage 530 stores a program for controlling the whole operation of the network apparatus and temporary data generated during the execution of the program.

The interface module 510 is a module for communicating with another node and includes an RF processor, a cable processor, an RF baseband processor, and a cable baseband processor. The cable processor converts an optical communication signal received through an optical cable or another cable signal into a baseband signal and provides the baseband signal to the cable baseband processor. Also, the cable processor converts a baseband signal received from the cable baseband processor into an optical communication signal or another cable signal suitable for cable transmission and transmits the optical communication signal or the cable signal. The RF processor converts a signal received through an antenna into a baseband signal and provides the baseband signal to the RF baseband processor. Further, the RF processor converts a baseband signal received from the RF baseband processor into an RF signal suitable for over-the-air transmission, and transmits the RF signal through the antenna.

In the above-described configuration, the controller 520 may perform the functions of the congestion state manager 540. Although separate units are provided for the respective functions of the controller 520, the controller 520 may be configured to perform all or some of the functions of the congestion state manager 540.

As a result, when the mobile terminal cannot receive a dedicated resource because a cell connected to the mobile terminal is congested, the present invention allows the mobile terminal to select/reselect a neighboring cell that is not congested, and the neighboring cell allocates the dedicated resource to the mobile terminal. Therefore, the present invention can prevent interruption of a corresponding service of the dedicated resource due to a congestion state.

Alternate embodiments of the present invention can also include computer readable codes on a computer readable medium. A computer readable medium may be any data storage device that can store data that can be read by a computer system. A computer readable medium can include, for example, the storage 430 in FIG. 4, the storage 530 in FIG. 5, magnetic storage media (such as Read Only Memory (ROM), floppy disks, and hard disks, among others), optical recording media (such as CD-ROMs, Digital Video Discs (DVDs), etc.), storage mechanisms, such as carrier waves (such as transmission through the Internet), or the like. A computer readable medium can also be distributed over network coupled computer systems so that the computer readable code is stored and executed in a distributed fashion. Also, functional programs, codes, and code segments for accomplishing the present invention can be construed by programmers of ordinary skill in the art to which the present invention pertains.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for a dedicated resource request using congestion information in a mobile communication system, the method comprising:
determining a dedicated resource state of a first cell connected to a mobile terminal using system information from the first cell;
selecting or reselecting a neighboring cell that is not congested when a dedicated resource of the first cell is congested; and
requesting the dedicated resource from the neighboring cell.

2. The method of claim 1, further comprising allocating the dedicated resource to the mobile terminal after requesting the dedicated resource.

3. The method of claim 1, wherein the mobile terminal obtains dedicated resource state information using system information from the first cell connected to the mobile terminal and neighboring cells.

4. A method for transmitting dedicated resource congestion information in a mobile communication system, the method comprising:
incorporating dedicated resource congestion information of a cell into system information; and
broadcasting the system information including the dedicated resource congestion information.

5. An apparatus for a dedicated resource request using congestion information in a mobile communication system, the apparatus comprising:
a controller for receiving system information from a network apparatus of a cell; and
a dedicated resource determiner for determining whether to request a dedicated resource from the cell or from a neighboring cell using congestion information in the received system information.

6. The apparatus of claim 5, wherein, when the controller receives a determination result of the dedicated resource determiner and requests the dedicated resource from the neighboring cell, the controller selects or reselects the neighboring cell and requests the dedicated resource from the neighboring cell.

7. An apparatus for dedicated resource allocation using congestion information in a mobile communication system, the apparatus comprising:
a congestion state manager for incorporating dedicated resource congestion information of a cell into system information; and
a controller for broadcasting the system information.

8. A system for a dedicated resource request using congestion information in a mobile communication system, the dedicated resource request system comprising:
a network apparatus for incorporating dedicated resource congestion information of a cell into system information and broadcasting the system information; and
a mobile terminal for determining a dedicated resource state of a first cell connected to the mobile terminal using system information from the first cell, when the mobile terminal requests a dedicated resource, selecting or reselecting a neighboring cell that is not congested when the dedicated resource of the first cell is congested, and requesting the dedicated resource from the neighboring cell.

9. The system of claim 8, wherein the mobile terminal receives system information of the first cell connected to the mobile terminal and a neighboring cell and obtains associated dedicated resource state information.

10. A computer-readable recording medium having recorded thereon a program for requesting a dedicated resource using congestion information in a mobile communication system, the program comprising:
a first code segment for determining a dedicated resource state of a first cell connected to a mobile terminal using system information from the first cell;
a second code segment for selecting or reselecting a neighboring cell that is not congested when the dedicated resource of the first cell is congested; and
a third code segment for requesting the dedicated resource from the neighboring cell.

11. A computer-readable recording medium having recorded thereon a program for transmitting dedicated resource congestion information in a mobile communication system, the program comprising:
a first code segment for incorporating a dedicated resource congestion information of a cell into system information; and
a second code segment for broadcasting the system information.

12. A method for a dedicated resource request using congestion information in a mobile terminal, the method comprising:
determining a dedicated resource state of a first cell connected to the mobile terminal using a system information from the first cell;
selecting or reselecting a neighboring cell that is not congested when a dedicated resource of the first cell is congested; and
requesting the dedicated resource from the neighboring cell.

13. The method of claim 12, further comprising allocating the dedicated resource to the mobile terminal after requesting the dedicated resource.

14. A method for transmitting dedicated resource congestion information in a base station, the method comprising:
incorporating dedicated resource congestion information of a cell into system information; and
broadcasting the system information.

15. A mobile terminal for a dedicated resource request using congestion information, the mobile terminal comprising:
means for determining a dedicated resource state of a first cell connected to the mobile terminal using system information from the first cell, when the mobile terminal requests a dedicated resource;
means for selecting or reselecting a neighboring cell that is not congested when the dedicated resource of the first cell is congested; and
means for requesting the dedicated resource from the neighboring cell;

16. A base station for transmitting dedicated resource congestion information in a base station, the base station comprising:
means for incorporating dedicated resource congestion information of a cell into a system information; and
means for broadcasting the system information.

17. A method for a dedicated resource request and transmit system using congestion information in a mobile communication system, the method comprising:
broadcasting, at a network apparatus, system information including dedicated resource congestion information of a first cell;
receiving, at a mobile terminal, the system information;
selecting or reselecting, at the mobile terminal, a neighboring cell that is not congested when the first cell is congested, when a dedicated resource is requested from the first cell; and
requesting, at the mobile terminal, the dedicated resource from the neighboring cell.

18. An apparatus for a dedicated resource request using congestion information in a mobile communication system, the apparatus comprising:
means for determining a dedicated resource state of a cell connected to a mobile terminal using system information from the cell;
means for selecting or reselecting a neighboring cell that is not congested when a dedicated resource of the cell is congested; and
means for requesting the dedicated resource from the neighboring cell.

19. The apparatus of claim 18, further comprising:
means for allocating the dedicated resource to the mobile terminal after requesting the dedicated resource.

20. An apparatus for transmitting dedicated resource congestion information in a mobile communication system, the apparatus comprising:
means for incorporating dedicated resource congestion information of a cell into system information; and
means for broadcasting the system information.
